(19) United States
(12) Patent Application Publication
(10) Pub. No.: US 2008/0171576 A1
(43) Pub. Date: Jul. 17, 2008

(54) System and Method for Identifying a Mobile Device

(76) Inventor: Daniel BROWN, East Northport, NY (US)

Correspondence Address: FAY KAPLUN & MARCIN, LLP, 150 BROADWAY, SUITE 702, NEW YORK, NY, 10038, US

(21) Appl. No.: 11/678,852

(22) Filed: Feb. 26, 2007

Related U.S. Application Data
(60) Provisional application No. 60/884,673, filed on Jan. 12, 2007.

(51) Int. Cl. H04M 1/00

(52) U.S. Cl. 455/557; 455/573

(57) ABSTRACT

A system and method identifies a mobile unit in a cradle. The method comprises deactivating power to the cradle. The cradle is capable of recharging the mobile unit. After the cradle is deactivated, the method comprises determining one of (a) if a signal is received from the mobile unit indicating recharging power to the mobile unit has been deactivated and (b) if the mobile unit discontinues an identification transmission. The method comprises determining an identity of the mobile unit in the cradle as a function of one of the received signal and the discontinued identification transmission.

### PRIORITY CLAIM

This application claims the priority to the U.S. Provisional Application Ser. No. 60/884,673, entitled “System and Method for Identifying a Mobile Device,” filed Jan. 12, 2007. The specification of the above-identified application is incorporated in its entirety herewith by reference.

### FIELD OF THE INVENTION

The present invention relates generally to identifying location data regarding mobile devices disposed in an area.

### BACKGROUND

A mobile unit may be used in a variety of environments. The mobile unit may include a communication device to notify a server (i.e., central processing unit) of the mobile unit's current state. The mobile unit may periodically or continuously send a signal to the server to perform this notification. When a plurality of mobile units is disposed in an area, the server may maintain a database logging each mobile unit's current state. For example, the server may update a spreadsheet containing location data of the plurality of mobile units contained in a network in which the server operates.

A problem arises when the mobile unit disposed in the network is incapable of notifying the server of its current state. This problem may occur when, for example, the mobile unit does not have enough power to make the transmission. Furthermore, this problem may occur when, for example, the mobile unit is recharging. The mobile unit may be recharged when it is placed within a cradle. The cradle may contain a first set of electrical contacts that couple to a corresponding set of contacts on the mobile unit to achieve the charging. A conventional method for the server to ascertain a recharging mobile unit's location is to utilize a second set of contacts on a cradle. The second set of contacts couples to another corresponding set of contacts on the mobile unit and is used to transmit a signal to the server. However, this requires that the mobile unit and the cradle to further include this second set of contacts. Thus, there is a need for updating the mobile unit's location without utilizing the second set of contacts.

### SUMMARY OF THE INVENTION

The present invention relates to a system and method for identifying a mobile unit in a cradle. The method comprises deactivating power to the cradle. The cradle is capable of recharging the mobile unit. After the cradle is deactivated, the method comprises determining one of (a) if a signal is received from the mobile unit indicating recharging power to the mobile unit has been deactivated and (b) if the mobile unit discontinues an identification transmission.

The method comprises determining an identity of the mobile unit in the cradle as a function of one of the received signal and the discontinued identification transmission.

### DESCRIPTION OF THE DRAWINGS

FIG. 1 shows a system for identifying mobile units according to an exemplary embodiment of the present invention.

FIG. 2a shows a mobile unit that is part of the system of FIG. 1.

FIG. 2b shows a cradle that is part of the system of FIG. 1.

FIG. 3 shows a second cradle according to an exemplary embodiment of the present invention.

FIG. 4 shows a method for identifying mobile units in a cradle according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe a system and method for identifying a mobile unit (e.g., computing device, personal computer, laptop, pager, mobile device, cell phone, radio frequency identification device, scanner, etc.), particularly while the mobile unit is recharging. According to the exemplary embodiments of the present invention, components of the mobile unit may be used for identification without a need for a further communication contact (i.e., second set of contacts).

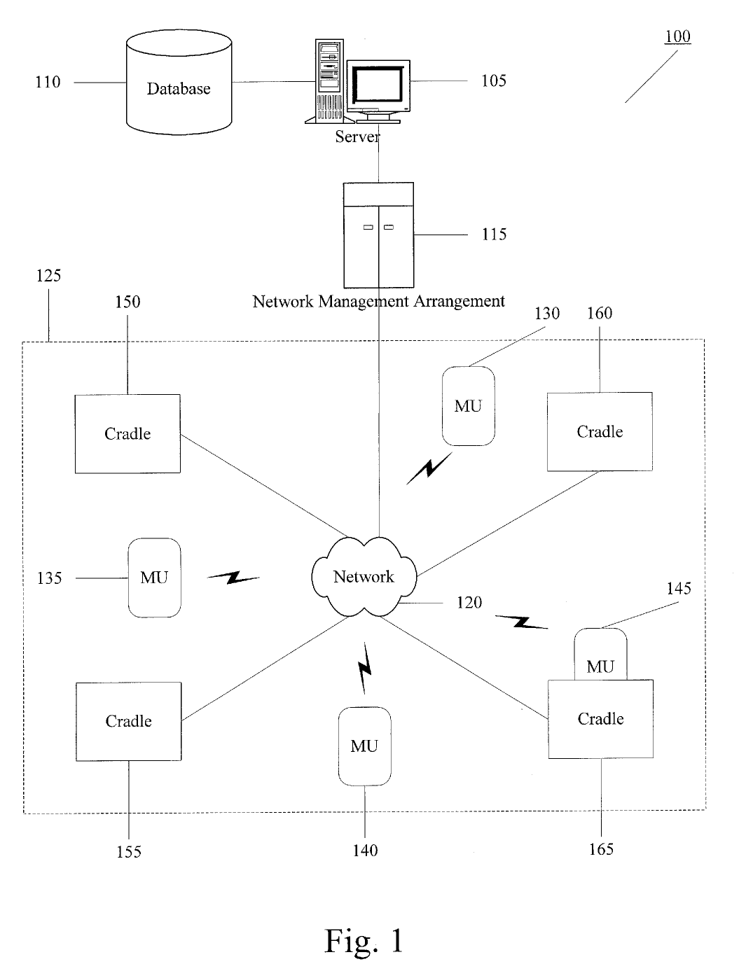

FIG. 1 shows a system 100 for identifying mobile units (MU) 130-145 according to an exemplary embodiment of the present invention. A server 105 may be disposed in the system 100. The server 105 may be connected to a database 110. The database 110 may be a memory used to store identification and location data associated with the MUs 130-145. The server 105 may also be connected to a network management arrangement (NMA) 115. The NMA 115 may cooperate with the server 105 to operate a network 120.

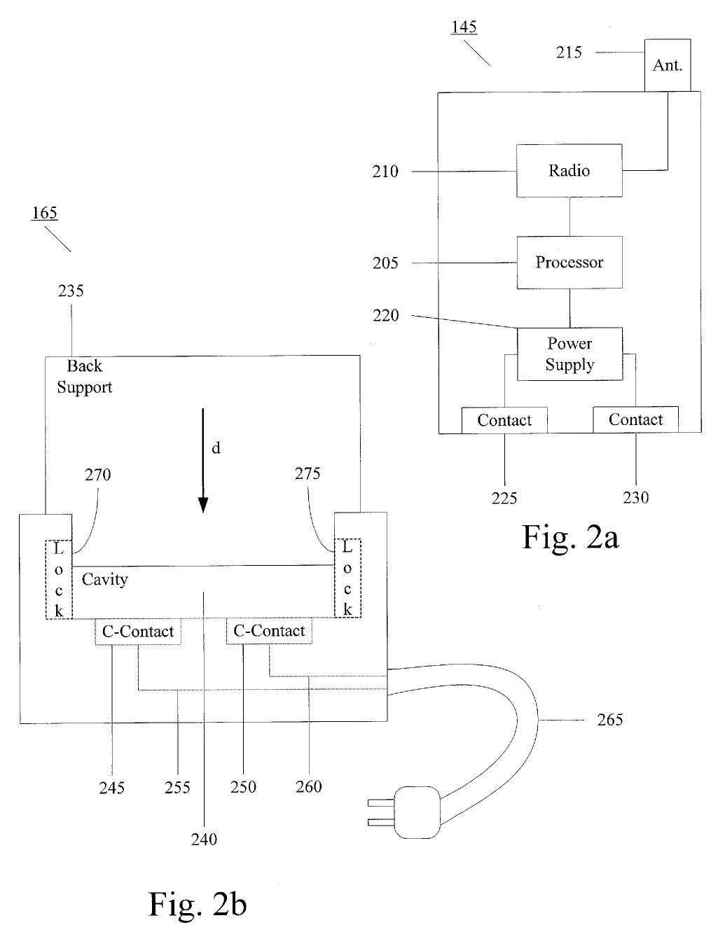

In the exemplary embodiment, the NMA 115 may further be connected to the network 120. The network 120 includes an operating area 125. The operating area 125 may be, for example, a warehouse, a store, a building, etc. The server 105 and/or the NMA 115 may, via the network 120, be in communication with the MUs 130-145 using wireless communications (e.g., 802.11x, WiFi, etc.) and/or hardwired communications. Cradles 150-165 may also be disposed in the operating area 125. The cradles 150-165 may be used to recharge a power supply of the MUs 130-145 via a recharging arrangement. For example, as illustrated, the MU 145 is inserted in the cradle 165. The cradles 150-165 may be in communication with the network 120 using wireless and/or hardwired communications. According to the exemplary embodiments of the present invention, the cradles 150-165 may be operated (e.g., activated/deactivated) via the server 105. The MU 145, the cradle 165, and the recharging arrangement will be discussed in more detail below with reference to FIGS. 2a-b.

It should be noted that the use of the NMA 115 is only exemplary and the server 105 alone may contain the functionalities to operate the system 100. Furthermore, the use of a single network 120 is only exemplary. The present invention may utilize multiple networks, thereby function in multiple, distinct operating areas. The present invention may also increase the operating area 125 using, for example, access points. The access points may be used to communicate with the MUs and/or cradles, via wireless and/or wired communications. In addition, it should be noted that the server 105, the database 110, and the NMA 115 disposed outside the operating area 125 is only exemplary and these components may be present within the operating area 125.

FIG. 2a shows the mobile unit 145 that is part of the system 100 of FIG. 1. FIG. 2b shows the cradle 165 that is part of the system of FIG. 1. The MU 145 may include a processor 205 connected to a radio 210 and a power supply 220. The processor 205 may perform the functionalities of the MU 145. The radio 210 is a communication device used to transmit/receive data via an antenna 215. The power supply 220 may be, for example, a rechargeable battery that includes contacts 225-230. It should be noted that the contacts 225-230 being separate from the power supply 220 is only exemplary and the contacts 225-230 may be part of the power supply 220.

The cradle 165 may include a back support 235, a cavity 240, corresponding contacts (c-contact) 245-250, and locks 270-275. The back support 235 may be used to provide a resting surface for the MU 145 upon insertion of the MU 145 by sliding in a direction d into the cradle 165. It should be noted that the use of the back support 235 is only exemplary and the cradle 165 may include side supports, an enclosure support, windows on any of the supports, or may not include any support. The cavity 240 may be used to provide a storing area for the MU 145 upon insertion of the MU 145 in the cradle 165. It should be noted that the use of the cavity 240 is only exemplary and the cradle 165 may be designed without the cavity 240.

The c-contacts 245-250 may provide a coupling site for the contacts 225-230 where the electrical connection between the MU 145 and the cradle 165 is established. As illustrated, the contact 225 may couple with the c-contact 245 while the contact 230 may couple with the c-contact 250. It should be noted that the use of two pairs of coupling contacts is only exemplary and the recharging of the power supply 220 may require fewer or more electrical couplings. The c-contacts 245-250 may have wire leads 255-260, respectively, to an electrical power outlet via cord 265.

The locks 270-275 may be used to hold the MU 145 in the cradle 165 while the MU 145 is not in use, the power supply 220 is recharging, etc. The MU 145 may contain corresponding locks (not shown) if the locks 270-275 are of a coupling type. It should be noted that the use of the locks 270-275 may allow the cradle 165 to not require a back support 235 or a cavity 240. However, it should also be noted that the use of the locks 270-275 is only exemplary and the cradle 165 may not have the locks 270-275. Furthermore, it should be noted that the use of two locks 270-275 is only exemplary and the present invention may utilize a single lock, a circular lock, more than two locks, etc.

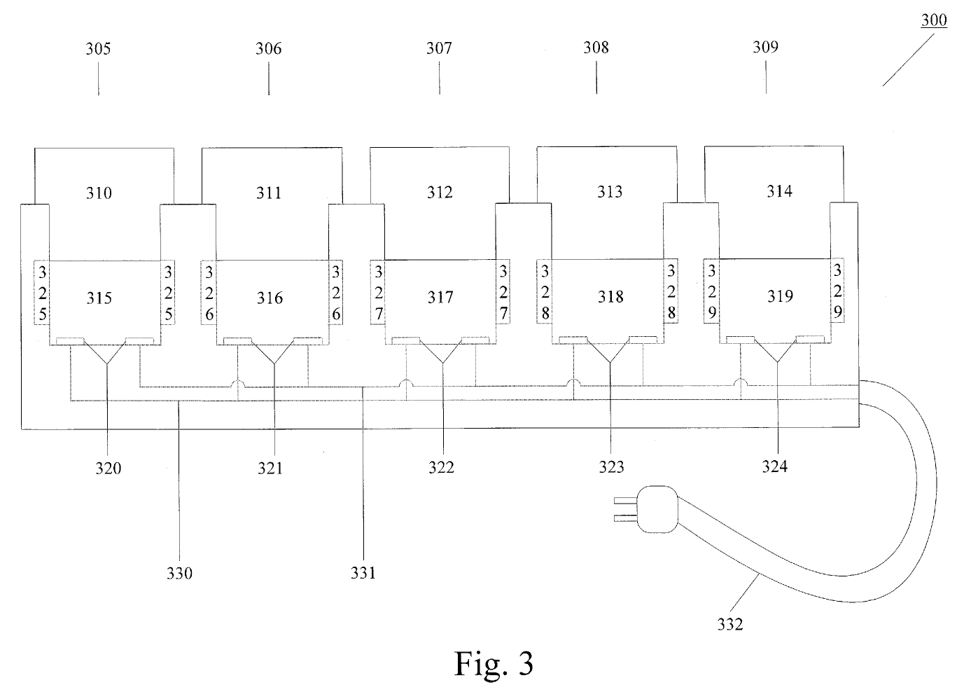

FIG. 3 shows a cradle 300 according to another exemplary embodiment of the present invention. The cradle 300 may be an array of cups 305-309, where each of the cups 305-309 substantially resembles the cradle 165 of FIG. 2b. As illustrated, the cups 305-309 may be arranged in a linear form. It should be noted that the linear form is only exemplary and the array of the cradle 300 may take any form such as a two dimensional matrix. The cups 305-309 may include back supports 310-314, cavities 315-319, contacts 320-324, and locks 325-329, respectively. The functionalities of the components for the cups 305-309 are substantially similar to the components of the cradle 165. One contact of each pair of contacts 320-324 is connected to a first wire lead 330 while the other contact of each pair of contacts 320-324 is connected to a second wire lead 331. The recharging takes place through these wire leads 330-331 via cord 332 connecting to a power source. In contrast to the server 105 controlling the cradle 165, because the cradle 300 includes multiple cups 305-309, the server 105 may operate the cradle 300 as a singular unit or operate the individual cups 305-309 on a per need basis.

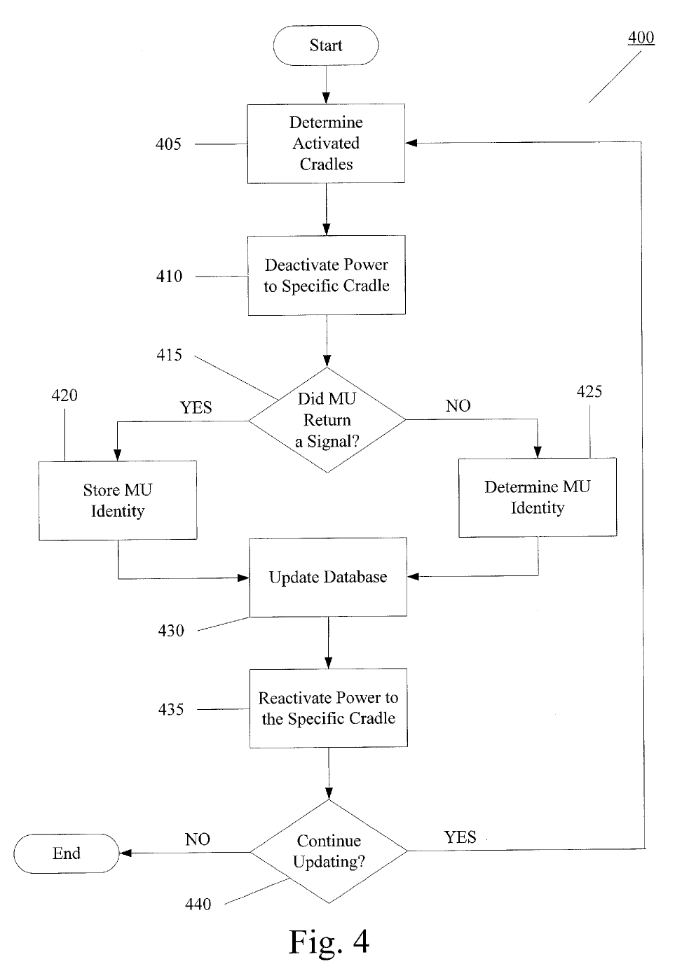

FIG. 4 shows a method 400 for identifying mobile units according to an exemplary embodiment of the present invention. The method 400 will be described with reference to the system 100 of FIG. 1. It should be noted that the method 400 may be used with the cradle 165 of FIG. 2b or with the cradle 300 of FIG. 3. Thus, the following description will incorporate the components of both the cradle 165 and the cradle 300.

The method 400 is directed toward identifying MUs that are being recharged, whether the MU has been recharging or just placed/loaded into the cradle. The method 400 assumes that the MUs with sufficient power are continuously communicating with the network, whether recharging in a cradle or in use within the operating area 125. MUs with insufficient power (e.g., dead battery) are unable to communicate and would, therefore, be in a recharging cradle. When the MU is not being recharged and is in use, the MU is in communication with the network 120 and, therefore, the server 105 may directly communicate with the MU to identify that MU. For example, as illustrated in FIG. 1, the server 105 may determine that MUs 130-140 are in use as they are wirelessly communicating with the server 105 via the network 120. Thus, through direct communication with MUs in use (e.g., MUs 130-140) and identifying MUs not in use (e.g., MU 145), a complete tally of all MUs disposed in the operating area 125 may be determined.

In step 405, the activated cradles are determined. As discussed above, the cradles 150-165 are connected to the network 120. The server 105 may determine the activated cradles using a variety of methods. For example, the cradles 150-165 may include functionality to indicate to the server 105 that there is a MU inserted therein or the MU is being recharged. The server 105 may also determine power consumption by the cradles 150-165. That is, if the cradle 165 is recharging the power supply 220 of the MU 145, energy consumption data may be used. If the consumption is beyond a threshold value, the server 105 may recognize that the cradle is currently in use. It should be noted that the server 105 may not be required to determine activated cradles and still perform the identification of MUs.

In step 410, power may be deactivated to a specific cradle among the active cradles. With reference to FIG. 3, power may be deactivated to a specific cup of the cradle 300. Once the cradle or cup is deactivated, a determination is made in step 415 whether the MU being recharged returned a signal. The signal may be, for example, a one bit signal to indicate that recharging power was terminated. However, those skilled in the art will understand that the MU may send any type of signal to indicate the termination of charging power.

If the MU being recharged has sufficient power after the cradle is deactivated, a signal may be returned. Thus, in step 420, the MU returned a signal to indicate the deactivation of recharging power and the MU identity is stored. Akin to an MU in use and directly communicating with the server 105 via the network 120, upon deactivation of the cradle, the MU may directly communicate with server 105 by sending the above described signal. Thus, the identity of the MU and the specific cradle in which it is being charged are identified by the server 105.

If the MU being recharged has insufficient power and cannot return a signal, the server 105 is still aware that the cradle is in use. Thus, in step 425, the identity of the MU may still be determined. In the exemplary embodiments, the MU with insufficient power may use the external power source (i.e., power received from recharging) to send transmissions, thereby enabling a continuous communication with the network. Therefore, the server 105 is receiving a signal from the MU. A deactivation of the cradle in which the insufficiently powered MU sits discontinues the transmissions from the MU. The server 105 subsequently determines that the MU that discontinued transmitting is present in the cradle that was deactivated. Thus, the identity of the MU and the specific cradle in which it is being charged are identified by the server 105.

In step 430, the database 110 is updated to store the identification and location data associated with the MU identified in either step 420 or step 425. Once the recharging MU is identified and the database 110 is updated, power is reactivated to the deactivated cradle in step 435.

In step 440, a determination is made whether to continue updating the database. If further updates are required, the method returns to step 405 where activated cradles are again identified. Those skilled in the art will understand that the method 400 may be used to continuously update the database 110 to show within which cradle each MU is located. Thus, in one example, the method 400 may be executed each time the server 105 detects that a cradle has been activated. In another example, the method 400 may continuously be executed to maintain a real-time catalog of the MUs present in cradles.

With the database 110 including the identification and location data for all the MUs within cradles in an operating area 125, other features may be implemented within the system 100. For example, the server 105 may further include functionality to activate/deactivate the locking mechanisms of the cradles. Thus, an MU locked in a cradle may only be used upon proper authentication and release by the server 105. For example, a user such as an employee or customer may arrive at the operating area 125 that includes a plurality of cradles or an array of cups having locked MUs. The user may swipe a credit card, employee badge, etc. through a swipe device that sends the user identification data to the server 105. The server 105 may then unlock a specific cradle allowing the user to take an identified MU. The server 105 may also associate the user identification with the MU identification and store the association in the database 110 to know which user has a specific MU.

Another example includes identifying misplaced MUs within the operating area. If a MU is misplaced and cannot respond to a query by the server 105, the server 105 may determine all other MUs in the operating area 125 and compare to a complete list of MUs that are supposed to be present in the operating area 125. A prompt may be issued to, for example, an administrator concerning the lost MU. The prompt may also include the identification of the user that unlocked the MU from the cradle.

It should be noted that the method 400 may include a checking step to determine that the MU which discontinued transmitting is present at the cradle (i.e., the MU identified in step 425). Upon reactivating power (step 435) to the deactivated cradle, the server 105 may determine that a signal is again being received from the MU. If a signal is being received from the MU that discontinued transmitting, the server 105 may authenticate that the identified MU is located in the specific cradle.

The present invention affords further advantages over conventional identification of mobile units. Conventional mobile units include recharging contacts (e.g., contacts 225-230) and a separate communication contact. In contrast, the present invention may eliminate the communication contact because identification may be accomplished through the method 400. The elimination of components of the MU also allows the design of the MU to be smaller, compact, etc. It also provides for less parts that may break and less possible environmental damage because there are fewer openings in the housing. It should be noted that the above described advantages are only exemplary and that other advantages exist for the system and method described above.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method for identifying a mobile unit in a cradle, comprising:
deactivating power to the cradle, the cradle being capable of recharging the mobile unit;
after the deactivating step, determining one of (a) if a signal is received from the mobile unit indicating recharging power to the mobile unit has been deactivated and (b) if the mobile unit discontinues an identification transmission; and
determining an identity of the mobile unit in the cradle as a function of one of the received signal and the discontinued identification transmission.

2. The method of claim 1, further comprising:
reactivating the cradle upon determining the identity.

3. The method of claim 1, wherein the mobile unit transmits the signal when the mobile unit has sufficiently stored power.

4. The method of claim 1, wherein the mobile unit discontinues the identification transmission when the mobile unit has insufficiently stored power.

5. The method of claim 1, wherein the mobile unit continuously transmits the identification transmission while recharging in the cradle.

6. The method of claim 1, further comprising:
locking the mobile unit into the cradle while recharging.

7. The method of claim 1, further comprising:
prior to deactivating the cradle, ascertaining whether the cradle is in use.

8. The method of claim 1, wherein the cradle is one of a plurality of recharging cradles.

9. The method of claim 8, further comprising:
deactivating each of the plurality of recharging cradles one at a time.

10. The method of claim 9, further comprising:
maintaining a database with each identification determined from each deactivation of the plurality of recharging cradles.

11. A system, comprising:
a mobile unit;
a cradle capable of recharging the mobile unit; and
a server deactivating power to the cradle, the mobile unit performing one of (a) sending a signal that the cradle is deactivated and (b) discontinuing an identification transmission, the server determining an identity of the mobile unit in the cradle as a function of one of the received signal and the discontinued identification transmission.

12. The system of claim 11, wherein the server reactivates the cradle upon storing the correlation.

13. The system of claim 11, wherein the mobile unit transmits the signal when the mobile unit has sufficiently stored power.

14. The system of claim 11, wherein the mobile unit discontinues the identification transmission when the mobile unit has insufficiently stored power.

15. The system of claim 11, wherein the mobile unit continuously transmits the identification transmission while recharging in the cradle.

16. The system of claim 11, further comprising:
a locking mechanism disposed on the cradle to lock the mobile unit into the cradle while recharging.

17. The system of claim 11, wherein, prior to deactivating the cradle, the server ascertains whether the cradle is in use.

18. The system of claim 11, wherein the cradle is one of a plurality of recharging cradles.

19. The system of claim 18, wherein the server deactivates each of the plurality of recharging cradles one at a time.

20. The system of claim 19, wherein the server maintains a database with each identification determined from each deactivation of the plurality of recharging cradles.
